(19) United States
(12) Patent Application Publication
(10) Pub. No.: US 2025/0043972 A1
(43) Pub. Date: Feb. 6, 2025

(54) DISTRIBUTED GEOTHERMAL OPEN-AIR COOLING SYSTEM

(71) Applicant: Exotherm, Inc., Houston, TX (US)

(72) Inventor: Michael J. PARRELLA, Katy, TX (US)

(21) Appl. No.: 18/717,746

(22) PCT Filed: Dec. 9, 2022
(86) PCT No.: PCT/US2022/081265

§ 371 Date: Jun. 7, 2024

Related U.S. Application Data
(60) Provisional application No. 63/287,793, filed on Dec. 9, 2021.

(51) Int. Cl. F24F 5/00; E04H 6/08; H02S 10/20; H02S 40/42

(52) U.S. Cl. CPC F24F 5/0046; F24F 5/0017; H02S 10/20; H02S 40/425; E04H 6/08; F24F 2005/0025; F24F 2005/0057; F24F 2005/0067

(57) ABSTRACT

A method and system for cooling an open air venue is provided. The system may include: one or more air intake ducts configured to intake warm air in an upper section of the venue; one or more air heat exchangers configured to receive the warm air from the one or more air intake ducts and remove heat from the warm air to output cold air; a cold water reservoir configured to store cold water and supply the cold water to the one or more air heat exchangers, where the cold water absorbs heat from the warm air in the one or more air heat exchangers; and a transmission and venting system configured to distribute the cold air into the venue.

### CROSS-REFERENCE TO RELATED APPLICATIONS

The present application claims the benefit of U.S. Provisional Patent Application 63/287,793, filed Dec. 9, 2021, which is incorporated by reference in its entirety.

### FIELD OF THE APPLICATION

The present application relates to an open-air cooling system, and more particularly, relates to a distributed geothermal open-air cooling system, such as for use in stadiums and other open air venues or environments.

### BACKGROUND OF THE DISCLOSURE

There are several scientific principles behind the open-air cooling solutions of the present application, including that: cold air is much heavier than warm air; cold air molecules are packed closer together; the amount of water vapor in the air also affects the density of the air; the more water vapor in the air, the less dense the air becomes; and cold, dry air is much heavier than warm, humid air. Table I below shows the density of air at different temperatures:

TABLE I

| | | |
|---|---|---|
| Temperature | Density | Specific Weight |

| [° C.] | [kg/m³] | [lbₘ/ft³] | [N/m³] | [lbₜ/ft³] |
|---|---|---|---|---|
| −10 | 1.341 | 0.0837 | 13.15 | 0.0837 |
| −5 | 1.316 | 0.0821 | 12.9 | 0.0821 |
| 0 | 1.292 | 0.0806 | 12.67 | 0.0806 |
| 5 | 1.268 | 0.0792 | 12.44 | 0.0792 |
| 10 | 1.246 | 0.0778 | 12.22 | 0.0778 |
| 15 | 1.225 | 0.0765 | 12.01 | 0.0765 |
| 20 | 1.204 | 0.0752 | 11.81 | 0.0752 |
| 25 | 1.184 | 0.0739 | 11.61 | 0.0739 |
| 30 | 1.164 | 0.0727 | 11.42 | 0.0727 |
| 40 | 1.127 | 0.0704 | 11.06 | 0.0704 |
| 50 | 1.093 | 0.0682 | 10.72 | 0.0682 |
| 60 | 1.06 | 0.0662 | 10.4 | 0.0662 |
| 80 | 1 | 0.0625 | 9.81 | 0.0625 |
| 100 | 0.9467 | 0.0591 | 9.28 | 0.0591 |

A target air temperature would be 25° C. (77° F.), and not above this temperature. Using the International Stadium in Riyadh, Saudi Arabia as an example, the cost of construction was about 1.912 billion Saudi riyals or US$510 million. The stadium's roof shades over 67,000 seats and covers an area of 47,000 square feet. The 24 columns are arranged in a circle with a 247-meter diameter. The umbrella keeps the sun off the seats and concourse slabs, providing shade and comfort in the hot desert climate.

### SUMMARY OF THE DISCLOSURE

The present application relates to a thermally optimized geothermal energy solution for cooling open-air venues. Benefits and attributes of the system include: providing pre-cooled air to conventional chillers using green distributed geothermal energy to reduce electrical consumption of the system; utilizing an insulated modular cold water reservoir that minimizes energy loss; utilizing insulated pipe that insulates all transportation pipes for moving cold water minimizes energy loss; utilizing insulated pipe for cold air distribution that minimizes energy loss; providing designs that can be used for future solutions; and using solar energy to provide electricity, and any excess electricity can be sold to a grid or used by a facility.

In accordance with a first aspect of the present application, a system for cooling a venue is provided. The system may include: one or more air intake ducts configured to intake warm air in an upper section of the venue; one or more air heat exchangers configured to receive the warm air from the one or more air intake ducts and remove heat from the warm air to output cold air; a cold water reservoir configured to store cold water and supply the cold water to the one or more air heat exchangers, wherein the cold water absorbs heat from the warm air in the one or more air heat exchangers; and a transmission and venting system configured to distribute the cold air into the venue. The venue of the system may be an open-air venue.

Implementations of the system of the first aspect of the present application may include one or more of the following features, alone or in combination. Each of the one or more air heat exchangers may include one or more air cooling coils configured to receive the cold water from the cold water reservoir, where the cold water passes through the one or more air cooling coils and absorbs heat from the warm air therein; and where the one or more air cooling coils are configured to output warm water. Each of the one or more air heat exchangers further may include a fan configured to pull the warm air in a first direction through the air heat exchanger, and where the one or more air cooling coils are configured to provide a flow of the cold water in a second direction through the air heat exchanger, the second direction being opposite the first direction.

The system may further comprise a water cooling system providing the cold water to the cold water reservoir, wherein the warm water is output from the one or more air heat exchangers and provided to the water cooling system for cooling. The water cooling system may include: a first water cooling device configured to receive the warm water output from the one or more air heat exchangers and provide a first stage cooling; a second water cooling device configured to receive an output from the first water cooling device and provide a second stage cooling and output the cold water for storage in the cold water reservoir; and a water supply line configured to provide the cold water from the second water cooling device to the cold water reservoir. The first water cooling device may include a geothermal cooling system, comprising: a pipeline receiving the warm water for transport therethrough to the second water cooling device; a water cooling coil arranged around or within the pipeline configured to circulate a cooling fluid which absorbs heat from the warm water; and one or more thermally insulated pipes arranged in an underground well configured to: transport an output from the water cooling coil, the output including the cooling fluid after absorbing heat from the warm water, into a below ground cold zone for releasing heat from the cooling fluid to the below ground cold zone, and transport the cooling fluid from the cold zone, after the release of heat from to the below ground cold zone, to the water cooling coil as an input of the cooling fluid to the water cooling coil. Alternatively, the first water cooling device may include a geothermal cooling system comprising one or more thermally insulated pipes arranged in an underground well configured to: transport the warm water into a below ground cold zone for releasing heat from the warm water to the below ground cold zone to provide cooled water, and transport the cooled water from the cold zone above ground for providing to the second water cooling device. The second water cooling device may include one or more compressors configured to cool a fluid passing therethough and output the fluid to the cold water reservoir, wherein the first stage cooling is configured to reduce cooling requirements and energy consumption by the one or more compressors.

In additional or alternative embodiments of the system of the first aspect of the present application, the system further comprises an array of solar panels; and may further comprise a storage battery configured to receive electricity from the array of solar panels where the transmission and venting system is configured to distribute the cold air into the array of solar panels, wherein the storage battery is configured to supply electricity to one or more of the first water cooling device and the second water cooling device. The second water cooling device may include one or more compressors configured to cool a fluid passing therethough, wherein the one or compressors are powered by electricity supplied by the storage battery. The system may further include one or more pumps configured to pump the cold water from the cold water reservoir to the one or more air heat exchangers, and the one or more pumps can be powered by electricity supplied by the storage battery. Additionally or alternatively, the array of solar panels can be arranged on an open air automobile parking area, and the transmission and venting system is further configured to distribute the cold air into the open air automobile parking area. In additional or alternative embodiments of the system of the first aspect of the present application, the cold water reservoir may include a plurality of storage tanks encased in a concrete insulation.

The one or more air heat exchangers of the system may be configured to output the cold air to the transmission and venting system, and the transmission and venting system may include one or more air delivery ducts may include a plurality of vents therein to distribute the cold air into the venue. The transmission and venting system further may include a plurality of vertical suspension beams configured to suspend the one or more air delivery ducts from a structure.

In accordance with a second aspect of the present application, a method for cooling a venue is provided, which may comprise: intaking warm air in an upper section of the venue into one or more air intake ducts; supplying the warm air from the one or more air intake ducts to one or more air heat exchangers; storing cold water in a cold water reservoir and supplying the cold water from the cold water reservoir to the one or more air heat exchangers, wherein the cold water removes heat from the warm air in the one or one or more heat exchangers; outputting cold air from the one or more heat exchangers to a transmission and venting system; and distributing the cold air into the venue through a transmission and venting system. The venue can be an open-air venue.

Implementations of the system of the first aspect of the present application may include one or more of the following features, alone or in combination Each of the one or more air heat exchangers may include one or more air cooling coils, and the method further may include: receiving, by the one or more air cooling coils, the cold water from the cold water reservoir; passing the cold water through the one or more air cooling coils, where the cold water absorbs heat from the warm air passing through the air heat exchanger; and outputting, by one or more air cooling coils, warm water. The method may further comprise pulling the warm air through the one or more air heat exchangers in a first direction by a fan, and providing a flow of the cold water in a second direction through the air heat exchanger, the second direction being opposite the first direction.

The method may include providing the cold water to the cold water reservoir by a water cooling system, where the warm water is output from the one or more air heat exchangers and provided to the water cooling system for cooling. The water cooling system may include: a first water cooling device receiving the warm water output from the one or more air heat exchangers and performing a first stage cooling; a second water cooling device receiving an output from the first water cooling device, performing a second stage cooling, and outputting the cold water for storage in the cold water reservoir; and a water supply line providing the cold water from the second water cooling device to the cold water reservoir. The first stage cooling may include: receiving the warm water in a pipeline for transport therethrough to the second water cooling device; circulating a cooling fluid through a water cooling coil arranged around or within the pipeline which absorbs heat from the warm water; transporting an output including the cooling fluid after absorbing heat from the warm water from the water cooling coil through one or more thermally insulated pipes into a below ground cold zone for releasing heat from the cooling fluid to the below ground cold zone; and transporting the cooling fluid from the cold zone through the one or more thermally insulated pipes, after the release of heat from to the below ground cold zone, to the water cooling coil as an input of the cooling fluid to the water cooling coil. The second water cooling device may include one or more compressors configured to cool a fluid passing therethough and output the fluid to the cold water reservoir; and where the first stage cooling is configured to reduce cooling requirements and energy consumption by the one or more compressors.

In additional or alternative embodiments of the method, the venue may include an array of solar panels, and a storage battery configured to receive electricity from the array of solar panels; and the method further may include: the transmission and venting system distributing the cold air into the array of solar panels; and supplying electricity from the storage battery to one or more of the first water cooling device and the second water cooling device. The second water cooling device may include one or more compressors configured to cool a fluid passing therethough, where the one or compressors are powered by electricity supplied by the storage battery. The cold water reservoir may include a plurality of storage tanks encased in a concrete insulation.

### BRIEF DESCRIPTION OF THE DRAWINGS

FIG. 1 shows a distributed geothermal open air-cooling system according to the present application;

FIG. 2 shows an air distribution system for use in a distributed geothermal open air cooling system according to the present application;

FIG. 3 shows an air heat exchanger used in a distributed geothermal open air cooling system according to the present application;

FIG. 4 shows a water cooling closed loop flow for a distributed geothermal open air cooling system according to the present application;

FIG. 5 shows an example of a distributed geothermal water cooling system for use in a distributed geothermal open air cooling system according to the present application;

FIG. 6 shows a modular, insulated cold water storage reservoir a distributed geothermal open air-cooling system according to the present application; and

FIG. 7a shows an end view of an application of a distributed geothermal open air-cooling system in a parking area with a solar panel array according to the present application; and

FIG. 7b shows a side view of the system of FIG. 7a.

### DETAILED DESCRIPTION OF THE DRAWINGS

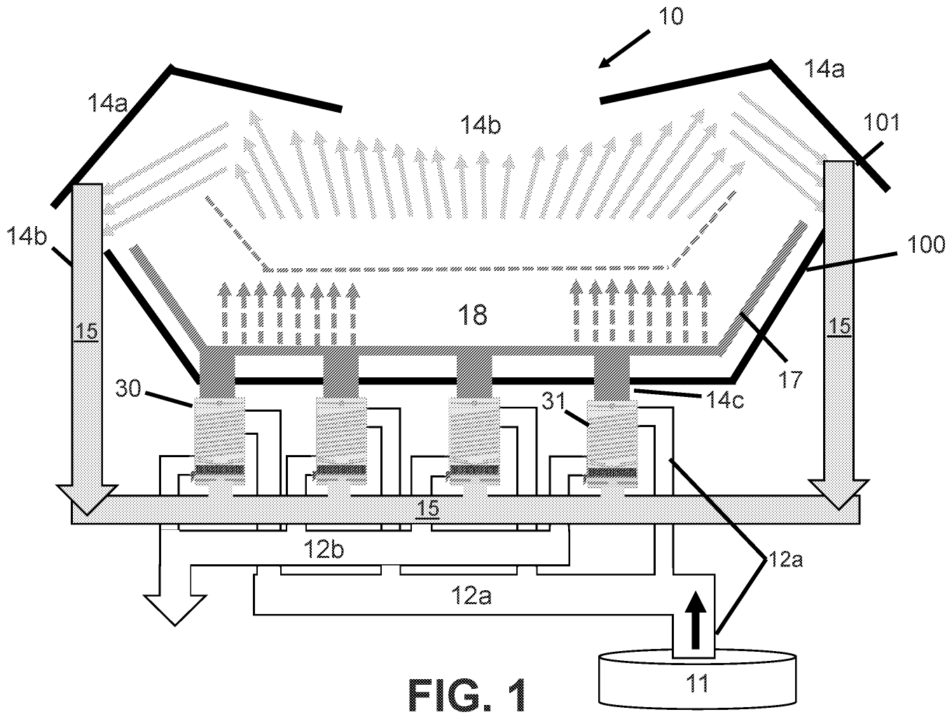

The distributed geothermal open air cooling systems of the present application, and the elements and components thereof, will now be described with reference made to FIGS. 1-7b.

FIG. 1 shows an example of an open-air cooling system 10 according to the present application with air flows in a stadium 100. The system 10 as illustrated in FIG. 1 is designed to circulate air through a stadium or other venue 100 in such a way that enables cold air 14c to be circulated through the venue 100 to keep the venue 100 cool for those in attendance, and the system 10 may incorporate geothermal cooling components.

In the environment of the venue 100, the hottest air 14a may be outside of the venue 100 above the top 101 of the venue 100. As air rises within the venue 100, warm air 14b reaches the top 101 of the venue 100. The warm air 14b at or near the top 101 of the venue 100 is pulled into air intake and return ducts 15 by fans or other mechanisms configured to pull air into an air intake duct 15. The air intake and return ducts 15 deliver the warm air 14b to one or more heat exchangers 30, which each comprise an air cooling coil 31 and which are shown in FIG. 3.

The open-air cooling system 10 includes a cold water storage reservoir 11, supplying cold water 12a to the one or more air cooling coils 31 of the air heat exchangers 30. The air cooling coil 31 cools the warm air 14b and outputs cooled air 14c, as described in greater detail below, to a transmission and venting system 17 for delivering the cooled air 14c to the venue 100 in a cold zone 18, which may be where people are seated or congregate inside the venue 100. As the cold air 14c enters the venue 100, the air warms and rises, and the warm air 14b is delivered back through the air intake and return duct 15 to the air heat exchanger 30 for cooling again in the manner previously described.

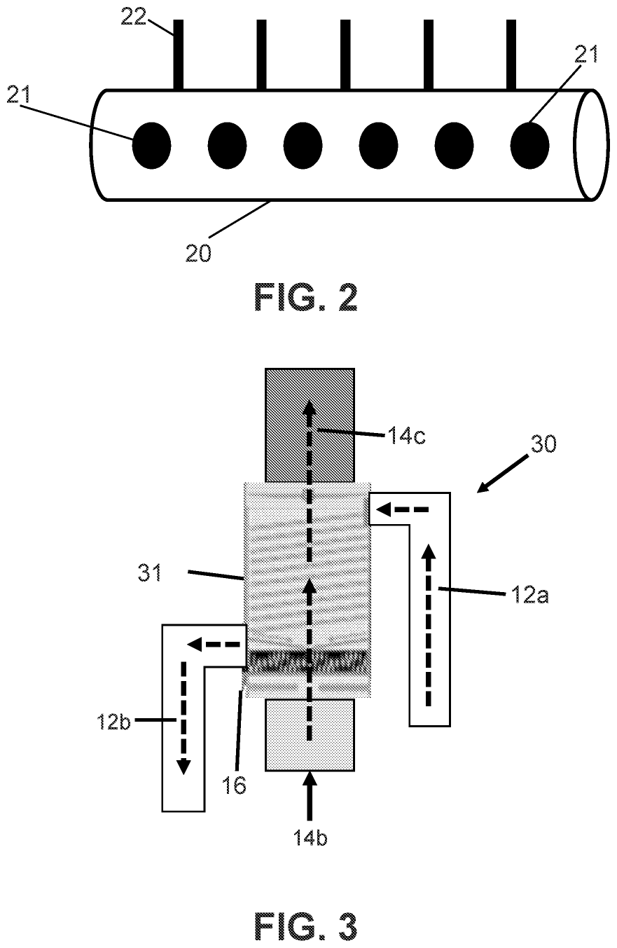

An under-seat automated cool air distribution system 20 may be used as part of the transmission and venting system 17. The distribution system 20 is configured to diffuse air accurately to target zones in the cold zone 18 of the venue 100. The distribution system 20 may also regulate air distribution by seating section. An example of a distribution system 20 comprising a duct with vents 21 is shown in FIG. 2. The distribution system 20 may also comprise vertical suspension beams 22 to suspend the distribution system 20 from a seat bottom, from support structures over the seating, or from another structure. The distribution system 20 also can be manufactured using composite technology that resists condensation, thereby maximizing cooling efficiency, and is designed to be unobtrusive and aesthetically pleasing.

FIG. 3 shows an example of an air heat exchanger 30 used in the open-air cooling system 10. The air heat exchanger 30 comprises an air cooling coil 31 which cools the warm air 14b passing through the air heat exchanger 30. The one or more coil(s) of the air cooling coil 31 receive cold water 12a as an input near the top of the air heat exchanger 30. The cold water 12a may be supplied by the cold water storage reservoir 11 or another cold water storage system. As the warm air 14b travels through the air heat exchanger 30 or is pulled through the air heat exchanger 30 by a fan, as shown in FIG. 3, heat from the warm air 14b is released and is absorbed by the cold water 12a moving through the air cooling coil 31. This causes the air 14b to cool and be output from the air heat exchanger 30 as cold air 14c, which is then distributed for cooling the venue 100 or another environment where it is used. The heat from the warm air 14b also warms the water flowing through the air cooling coil(s) 31, which is output from the air cooling coil(s) 31 as heated water 12b that is then be supplied to a system for re-cooling and storage as cold water 12a, such as a geothermal cooling system as described in greater detail below. The air heat exchanger 30 also comprises an area for collecting water condensation 16.

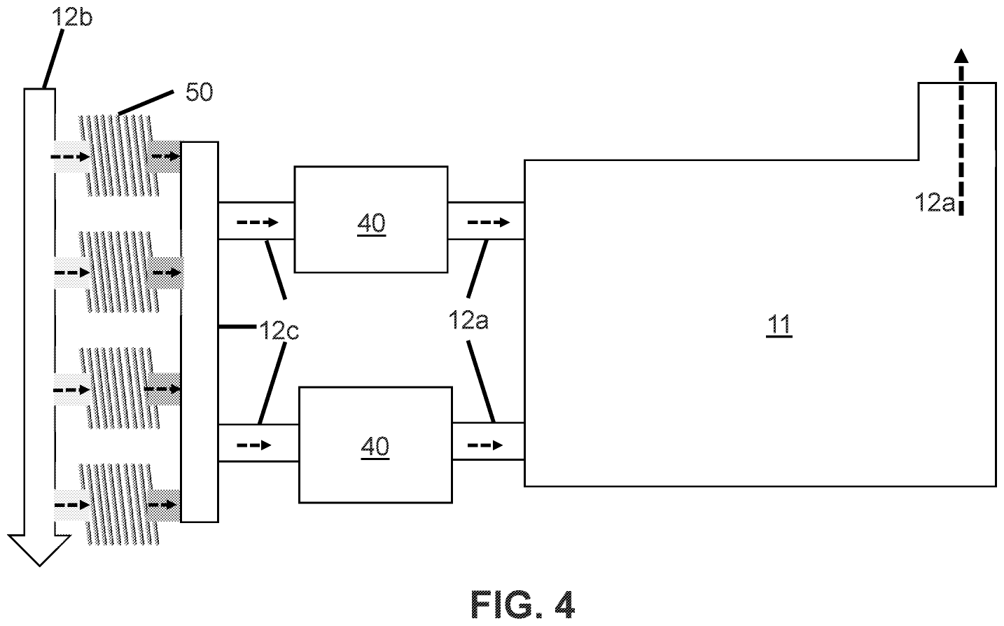

FIG. 4 shows water cooling closed loop flows for use in the distributed geothermal open air-cooling system 10, or in another arrangement for cooling warm water 12b. In this arrangement, although one or more compressors 40 are incorporated into the system for cooling the water, the system comprises alternative, additional cooling methods and the more that the conventional compressor 40 cooling is offloaded, the more energy savings are realized.

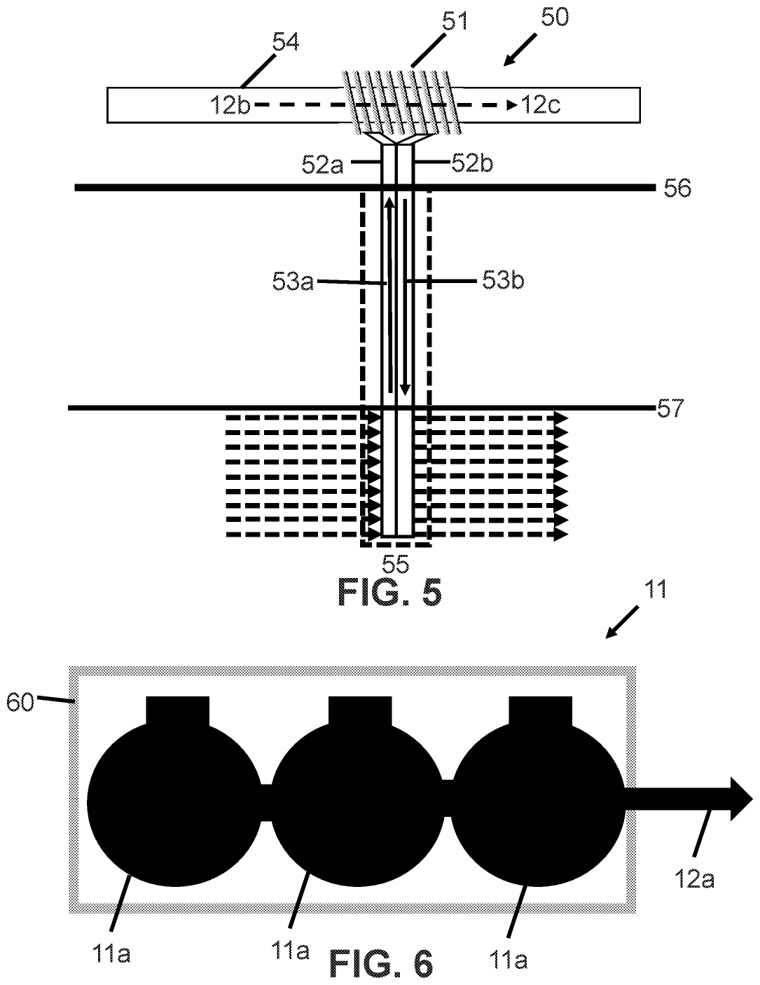

After cold water 12a is heated in the air heat exchanger 30 or by another arrangement, the warm water 12b is output and may be supplied to an arrangement as shown in FIG. 4. The warm water 12b may pass through a cooling coil 51 that is part of a distributed geothermal cooling system 50 for a first stage cooling, shown in greater detail in FIG. 5. The cooling coil 51 cools the water passing through, so that cooled water 12c is provided to compressors 40 for further cooling in a second stage cooling. The compressor(s) 40 then output the cold water 12a to a cold water storage reservoir 11 or other storage. By performing an initial, first stage cooling of the warm water 12b before providing it to the compressors 40, it significantly reduces the amount of cooling and energy that is required by the compressors 40 for the second stage cooling in comparison to if the warm water 12b were provided directly to the compressors 40 for cooling.

FIG. 5 shows an example of a distributed geothermal cooling system 50 that can be used in the cooling of warm water 12b. The heated water 12b return can be fed into a geothermal cooling system 50 to cool the heated water 12b before the cold water 12a is supplied back to the cold water storage reservoir 11 for circulation through the open-air cooling system 10 in FIG. 1.

The warm water 12b may travel through a pipe 54. One or more cooling coil(s) 51 may be arranged around or within a section of the pipe 54. A fluid, such as water, circulates through the cooling coil 51 and through heat pipes 52a, 52b in fluid communication with the cooling coil 51 at two ends of the cooling coil 51. The heat pipes 52a, 52b extend into a well 55 that is below ground 56, and extend into an underground cold zone 57 which can absorb heat.

The fluid circulation system for cooling the heated water 12b in the distributed geothermal cooling system 50 operates as follows. As the heated water 12b travels through the pipe 54 surrounded by the cooling coil 51, heat from the heated water 12b is released and absorbed by the cold fluid moving through the coil 41. This causes the water 12b to cool and the cooled water 12c is then provided for further cooling and storage. The heat from the warm water 12b also warms the water flowing through the cooling coil 51, which is output from the cooling coil 51 into the heat pipe 52b as heated fluid 53b. The heated fluid 53b passes through the heat pipe 52b and into the underground cold zone 57, where it releases heat to the underground surroundings, and cools. The cooled fluid 53a is then provided through the heat pipe 52a to the cooling coil 51 where it is used as the cooled fluid in the cooling coil 51 for cooling the heated water 12b.

The heat pipes 52a, 52b can be thermally insulated pipes, including those made and constructed as described in U.S. patent application Ser. No. 15/761,514 filed Mar. 20, 2018 and entitled “Thermally Insulating Pipes”, which is incorporated by reference in its entirety. The thermally insulating pipe may include a first pipe layer positioned in the center of the insulating pipe, surrounding an inner chamber of the insulating pipe, through which the contents of the insulating pipe travel. The first pipe layer can be formed from a fiber reinforced composite material impregnated with an epoxy resin, and may have a thickness of one-eighth of an inch. An insulation layer is provided around the first pipe layer, and can be made from a resin-saturated and non-woven or woven material, including for example, glass, mineral fibers such as basalt, and silica aerogels, which may be in the form of a non-woven mat. A second pipe layer can be provided, surrounding the insulation layer, which may be formed of the same or similar fiber composite materials as the first pipe layer, and have a similar thickness. The second pipe layer may be further offset from the first pipe layer by up to 90°. The inclusion of additional pipe layers after the first pipe layer provides additional thermal insulation, and the buildup of the multiple layers provides boundary layers that aid in the development of the thermal properties of the pipe. An outer pipe layer is provided around the second pipe layer, which can be formed from a fiber reinforced composite material impregnated with an epoxy resin.

Alternatively to the previously described geothermal cooling method, the heated water 12b can be directly fed through the heat pipe 52b underground where it is delivered to the colder geothermal zone 57, where heat is released to the ground to cool the water 12b. The cooled water 12c is then circulated back up to the system through heat pipe 52a for providing to the compressor 40. By offloading the cooling of the heated water 12b to the geothermal system, less conventional compressor cooling is required, thereby saving energy.

FIG. 6 shows a modular, insulated cold water storage reservoir 11, storing cold water 12a for use in the distributed geothermal open-air cooling systems described herein, or other applications. After the circulated water is cooled by the distributed geothermal cooling system 50 and/or compressor(s) 40, it can be stored in the cold water storage reservoir 11, and pumped out of the cold water storage reservoir 11 as needed. In the embodiment illustrated in FIG. 6, the cold water storage reservoir 11 is modular, and includes a plurality of storage tanks 11a, which may be interconnected or separated. The cold water storage reservoir 11 may also comprise an insulating material around the storage tanks 11a, such as concrete insulation 60, to reduce heat absorption by the storage tanks 11a that may heat the cold water 12a.

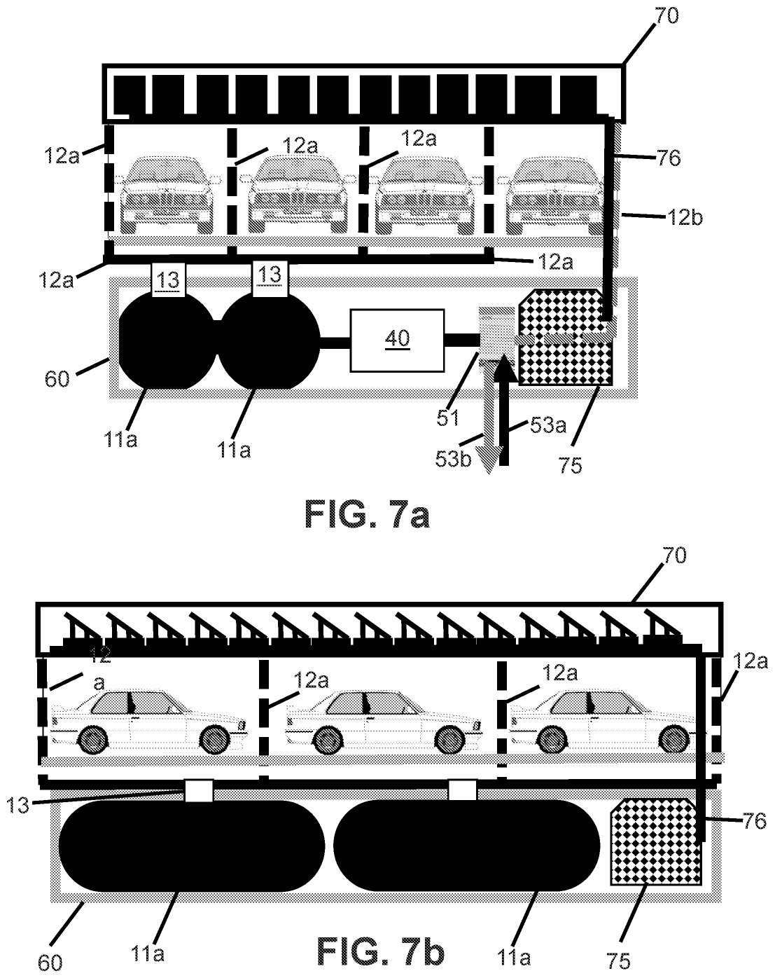

The features and components of the distributed geothermal air cooling system described herein may be used in systems having purposes other than heating of an open-air stadium or venue 100, or which may operate in conjunction with an open-air stadium or venue 100. FIGS. 7a and 7b show an end view and a side view of a simplified diagram of a distributed geothermal air cooling system, comprising a modular and insulated cold water storage reservoir 11 that may be combined with solar energy canopies 70 in an automobile parking area, such as a parking garage or a parking lot. Solar parking canopies are built in existing parking areas, with solar power and storage for cooling open-air venues and stadiums. The modular insulated solar canopies 70 with solar panels have several open-air venue uses, including stadiums, parking spaces, walkways, gathering areas, bus stops, train stations, streets, roof tops, open-air markets, airports, and courtyards.

The solar array 70 comprises solar panels, which provide electricity to a battery power storage 75 connected to the solar array 70 by cables 76. The battery power storage 75 can be used to supply electricity to the system components, such as pumps 13 or a compressor 40 for cooling water from the geothermal heat exchange, as previously described, receiving warmed water 12b from the solar array 70, or the electricity can be stored for other uses. The cold water 12a can be delivered by pumps 13 from the cold water storage tanks 11a to one or more air heat exchangers (not shown) that are used to provide cooled air to the solar array 70, parking area, or other open air-venue, in a manner similar to that described above in FIGS. 1-5. For example, the solar array 70 and/or the parking area may comprise one or more of air return ducts 15 for collecting warm air, air heat exchangers 30 and/or air distribution systems 20, which operate in a manner similar to that described above by intaking warm air which is cooled by a cooling coil using cold water 12a to output cooled air to the environment, such as the parking area and/or the solar array 70.

It should be understood that, unless stated otherwise herein, any of the features, characteristics, alternatives or modifications described regarding a particular embodiment herein may also be applied, used, or incorporated with any other embodiment described herein. Also, the Figures herein are not drawn to scale. Although the invention has been described and illustrated with respect to exemplary embodiments thereof, the foregoing and various other additions and omissions may be made therein and thereto without departing from the spirit and scope of the present invention.

What is claimed:

1. A system for cooling a venue, comprising:
one or more air intake ducts configured to intake warm air in an upper section of the venue;
one or more air heat exchangers configured to receive the warm air from the one or more air intake ducts and remove heat from the warm air to output cold air;
a cold water reservoir configured to store cold water and supply the cold water to the one or more air heat exchangers, wherein the cold water absorbs heat from the warm air in the one or more air heat exchangers; and
a transmission and venting system configured to distribute the cold air into the venue.

2. The system according to claim 1, wherein each of the one or more air heat exchangers comprise one or more air cooling coils configured to receive the cold water from the cold water reservoir, wherein the cold water passes through the one or more air cooling coils and absorbs heat from the warm air therein; and
wherein the one or more air cooling coils are configured to output warm water.

3. The system according to claim 2, wherein each of the one or more air heat exchangers further comprise a fan configured to pull the warm air in a first direction through the air heat exchanger, and wherein the one or more air cooling coils are configured to provide a flow of the cold water in a second direction through the air heat exchanger, the second direction being opposite the first direction.

4. The system according to claim 2, further comprising a water cooling system providing the cold water to the cold water reservoir, wherein the warm water is output from the one or more air heat exchangers and provided to the water cooling system for cooling.

5. The system according to claim 4, wherein the water cooling system comprises:
a first water cooling device configured to receive the warm water output from the one or more air heat exchangers and provide a first stage cooling;
a second water cooling device configured to receive an output from the first water cooling device and provide a second stage cooling and output the cold water for storage in the cold water reservoir; and
a water supply line configured to provide the cold water from the second water cooling device to the cold water reservoir.

6. The system according to claim 5, wherein the first water cooling device comprises a geothermal cooling system, comprising:
a pipeline receiving the warm water for transport therethrough to the second water cooling device;
a water cooling coil arranged around or within the pipeline configured to circulate a cooling fluid which absorbs heat from the warm water; and
one or more thermally insulated pipes arranged in an underground well configured to:
transport an output from the water cooling coil, the output comprising the cooling fluid after absorbing heat from the warm water, into a below ground cold zone for releasing heat from the cooling fluid to the below ground cold zone, and
transport the cooling fluid from the cold zone, after the release of heat from to the below ground cold zone, to the water cooling coil as an input of the cooling fluid to the water cooling coil.

7. The system according to claim 5, wherein the first water cooling device comprises a geothermal cooling system, comprising:
one or more thermally insulated pipes arranged in an underground well configured to:
transport the warm water into a below ground cold zone for releasing heat from the warm water to the below ground cold zone to provide cooled water, and
transport the cooled water from the cold zone above ground for providing to the second water cooling device.

8. The system according to claim 6, wherein the second water cooling device comprises one or more compressors configured to cool a fluid passing therethough and output the fluid to the cold water reservoir; and
wherein the first stage cooling is configured to reduce cooling requirements and energy consumption by the one or more compressors.

9. The system according to claim 1, wherein the cold water reservoir comprises a plurality of storage tanks encased in a concrete insulation.

10. The system according to claim 1, further comprising:
an array of solar panels; and
wherein the transmission and venting system is configured to distribute the cold air into the array of solar panels.

11. The system according to claim 6, further comprising:
an array of solar panels; and
a storage battery configured to receive electricity from the array of solar panels
wherein the transmission and venting system is configured to distribute the cold air into the array of solar panels; and
wherein the storage battery is configured to supply electricity to one or more of the first water cooling device and the second water cooling device.

12. The system according to claim 11, wherein the second water cooling device comprises one or more compressors configured to cool a fluid passing therethough, wherein the one or compressors are powered by electricity supplied by the storage battery.

13. The system according to claim 1, wherein the venue is an open-air venue.

14. The system according to claim 1, wherein the one or more air heat exchangers are configured to output the cold air to the transmission and venting system, and the transmission and venting system comprises one or more air delivery ducts comprising a plurality of vents therein to distribute the cold air into the venue.

15. The system according to claim 14, wherein the transmission and venting system further comprises a plurality of vertical suspension beams configured to suspend the one or more air delivery ducts from a structure.

16. The system according to claim 10, wherein the array of solar panels is arranged on an open air automobile parking area, and
wherein transmission and venting system is further configured to distribute the cold air into the open air automobile parking area.

17. The system according to claim 11, further comprising one or more pumps configured to pump the cold water from the cold water reservoir to the one or more air heat exchangers.

18. The system according to claim 17, wherein the one or more pumps are powered by electricity supplied by the storage battery.

19. A method for cooling a venue, the method comprising:
intaking warm air in an upper section of the venue into one or more air intake ducts;
supplying the warm air from the one or more air intake ducts to one or more air heat exchangers;
storing cold water in a cold water reservoir and supplying the cold water from the cold water reservoir to the one or more air heat exchangers, wherein the cold water removes heat from the warm air in the one or one or more heat exchangers;
outputting cold air from the one or more heat exchangers to a transmission and venting system; and
distributing the cold air into the venue through a transmission and venting system.

20. The method according to claim 19, wherein each of the one or more air heat exchangers comprise one or more air cooling coils, and the method further comprises:
receiving, by the one or more air cooling coils, the cold water from the cold water reservoir;
passing the cold water through the one or more air cooling coils, wherein the cold water absorbs heat from the warm air passing through the air heat exchanger; and
outputting, by one or more air cooling coils, warm water.

21. The method according to claim 20, further comprising:
pulling the warm air through the one or more air heat exchangers in a first direction by a fan, and
providing a flow of the cold water in a second direction through the air heat exchanger, the second direction being opposite the first direction.

22. The method according to claim 20, further comprising
providing the cold water to the cold water reservoir by a water cooling system, wherein the warm water is output from the one or more air heat exchangers and provided to the water cooling system for cooling.

23. The method according to claim 22, wherein the water cooling system comprises:
a first water cooling device receiving the warm water output from the one or more air heat exchangers and performing a first stage cooling;
a second water cooling device receiving an output from the first water cooling device, performing a second stage cooling, and outputting the cold water for storage in the cold water reservoir; and
a water supply line providing the cold water from the second water cooling device to the cold water reservoir.

24. The method according to claim 23, wherein the first stage cooling comprises:
receiving the warm water in a pipeline for transport therethrough to the second water cooling device;
circulating a cooling fluid through a water cooling coil arranged around or within the pipeline which absorbs heat from the warm water;
transporting an output comprising the cooling fluid after absorbing heat from the warm water from the water cooling coil through one or more thermally insulated pipes into a below ground cold zone for releasing heat from the cooling fluid to the below ground cold zone; and
transporting the cooling fluid from the below ground cold zone through the one or more thermally insulated pipes, after the release of heat from to the below ground cold zone, to the water cooling coil as an input of the cooling fluid to the water cooling coil.

25. The method according to claim 24, wherein the second water cooling device comprises one or more compressors configured to cool a fluid passing therethough and output the fluid to the cold water reservoir; and
wherein the first stage cooling is configured to reduce cooling requirements and energy consumption by the one or more compressors.

26. The method according to claim 19, wherein the cold water reservoir comprises a plurality of storage tanks encased in a concrete insulation.

27. The method according to claim 19, wherein the venue comprises an array of solar panel and the method further comprises the transmission and venting system distributing the cold air into the array of solar panels.

28. The method according to claim 25, wherein the venue comprises an array of solar panels, and a storage battery configured to receive electricity from the array of solar panels; and wherein the method further comprises:
the transmission and venting system distributing the cold air into the array of solar panels; and
supplying electricity from the storage battery to one or more of the first water cooling device and the second water cooling device.

29. The method according to claim 28, wherein the second water cooling device comprises one or more compressors configured to cool a fluid passing therethough, wherein the one or compressors are powered by electricity supplied by the storage battery.

30. The method according to claim 19, wherein the venue is an open-air venue.
